(19) United States
(12) Patent Application Publication
(10) Pub. No.: US 2026/0227615 A1
(43) Pub. Date: Aug. 6, 2026

(54) HYPER-THROUGHPUT, MULTIPLEX, SINGLE MOLECULE IMAGING PLATFORM

(71) Applicant: UNIVERSITY OF PITTSBURGH - OF THE COMMONWEALTH SYSTEM OF HIGHER EDUCATION, PITTSBURGH, PA (US)

(72) Inventors: Hongqiang Ma, Sewickley, PA (US); Yang Liu, Sewickley, PA (US)

(73) Assignee: UNIVERSITY OF PITTSBURGH - OF THE COMMONWEALTH SYSTEM OF HIGHER EDUCATION, PITTSBURGH, PA (US)

(21) Appl. No.: 19/149,114

(22) PCT Filed: Jan. 18, 2024
(86) PCT No.: PCT/US2024/011952

§ 371 Date: Jul. 18, 2025

Related U.S. Application Data
(60) Provisional application No. 63/440,600, filed on Jan. 23, 2023.

(51) Int. Cl. G02B 21/00; G01N 21/64; G02B 21/18; G02B 21/28

(52) U.S. Cl. CPC G02B 21/0076; G01N 21/6428; G01N 21/6458; G02B 21/0048; G02B 21/18; G02B 21/28; G01N 2201/06113; G01N 2201/0633; G01N 2201/0634; G01N 2201/08; G01N 2201/105

(57) ABSTRACT

A total internal reflection fluorescence microscopy system includes a light source, a light movement apparatus, such as a vibration motor or a 2D scanning device, coupled to an output of the light source, such as an RGB laser, for receiving a first light signal generated by the light source, the light movement apparatus being structured and configured to generate a second light signal from the first light signal, the second light signal being a light signal that moves in at least 2 dimensions, a prism structured to receive the second light signal and direct the second light signal to a sample, a lens assembly structured to receive an emission light signal emitted from the sample in response to the second light signal, and one or more light detectors, such as one or more industry grade cameras, coupled the lens assembly for receiving the emission light signal.

WO

### CROSS REFERENCE TO RELATED APPLICATIONS

This application claims priority to U.S. Provisional Patent Application Ser. No. 63/440,600, filed on Jan. 23, 2023 and titled “Hyper-Throughput, Multiplex, Single Molecule Imaging Platform,” the disclosure of which is incorporated herein by reference.

### STATEMENT OF GOVERNMENT INTEREST

This invention was made with government support under grant #CA254112 awarded by the National Institutes of Health (NIH). The government has certain rights in the invention.

### FIELD OF THE INVENTION

The present invention pertains to microscopy systems, and, in particular, to a microscopy technology platform for hyper-throughput biomarker detection at single molecule sensitivity that is built upon an optical configuration of total internal reflection fluorescence (TIRF) microscopy, but with several innovation strategies for significantly higher throughput, multiplicity and accuracy, which are well suited for single exosome analysis.

### BACKGROUND OF THE INVENTION

Exosomes are nano-sized (40-160 nm) extracellular vesicles (EVs) that are secreted from cells and that are critical components in the cell microenvironment and in intercellular communications. Exosomes carry rich fingerprint proteins and RNAs derived by the parental cells, including disease-associated proteins and microRNAs.

Several hallmarks of cancer have reportedly been impacted by exosome communication, including modulating immune responses, reprogramming stromal cells, remodeling the architecture of the extracellular matrix, or even endowing cancer cells with characteristics of drug resistance. Due to their relatively stable duration in the circulation system and their unique composition and functions, Exomes are widely considered as a crucial source of biomarkers from body fluid (e.g., blood, urine) indicative of many diseases, such as cancer, neurodegenerative diseases and/or cardiovascular diseases. The detection of exosome-derived cancer biomarkers has been a highly attractive strategy for earlier detection of cancer, prognosis and/or longitudinal monitoring of treatment response for individual patients.

A variety of methods have been reported for profiling various biomarkers (proteins, DNA, RNAs) from exosomes, such as ELISA, Western blotting, and flow cytometry, among others. Currently available and clinically viable diagnostics are all based on “bulk measurements” requiring 10⁵-10⁶ EVs per biomarker. Although the detection of exosome-derived cancer biomarkers has been extensively explored for over a decade, the major challenge is the lack of reproducibility. One of the key factors is that traditional analysis of bulk exosomes makes it extremely difficult to identify a small number of tumor-originating exosomes in a large background of highly heterogeneous exosomes due to their diverse cells of origin, the process of biogenesis and the specific stimuli in their microenvironment.

Single exosome (vesicle) analysis is crucial to improve diagnostic accuracy, and serves as an important tool for basic/translational research. For clinical diagnosis, the low diagnostic accuracy is likely due to coexistence with exosomes from tumor-free cells, and the low quantity of circulating biomarkers, especially at early stages of cancer. For basic and translational research, single exosome analysis could be extremely valuable in studying exosome biogenesis, tumor heterogeneity, rare tumor subtypes, phenotypic changes occurring during therapy, and host exosome variations that occur concomitantly with tumor changes.

Ideally, single exosome analysis requires four crucial attributes: (a) high detection sensitivity (the ability to reliably detect a small number of cancer-derived exosomes) from bulk EVs (10⁵-10⁶); (b) high specificity (low false positive exosomes); (c) high accuracy in quantifying biomarkers in a single exosome; and (d) multiplexed biomarker detection in a single exosome (the ability to detect multiple biomarkers co-localized in a single exosome).

The development of various technologies for single-exosome analysis has been actively pursued by many groups, with optical microscopy-based approaches, such as wide-field fluorescence microscopy, total internal reflection fluorescence (TIRF) microscopy and stochastic optical reconstruction microscopy (STORM), due to their superior sensitivity and resolution. Compared to conventional fluorescence microscopy, TIRF microscopy employs the phenomena of total internal reflection and the evanescent wave to selectively excite fluorophores located close to the surface of the coverslip within a depth of ~200nm, which can significantly reduce background and non-specific detection. Importantly, a TIRF objective lens typically has a high numerical aperture (NA), and thus can achieve a high signal collection efficiency (~82%) with state-of-the-art diffraction-limited resolution (~250nm). These technical attributes make TIRF microscopy an ideal system for detecting low fluorescence signals on single exosomes.

These microscopy-based approaches, however, suffer from various limitations. Both conventional fluorescence and TIRF microscopy have rather limited throughput. Both are diffraction-limited imaging systems with a resolution >250 nm, which cannot be used to measure the size of an exosome or accurately identify crowded exosomes. To ensure single exosome detection, the exosome concentration needs to be significantly diluted to ensure a sparse distribution on the coverslip with a neglectable percentage of the overlapping exosomes. Further, the field of view (FOV) of existing TIRF microscopy systems is usually limited (<100×100 μm²), and conventional fluorescence microscopy is only slightly larger. Although a scanning system can be used with hundreds of stitched images to mitigate such limitation to some extent, the accumulated exosomes are generally in the range of 10³-10⁴, about two orders of magnitude lower than most bulk measurements. In addition, conventional fluorescence microscopy uses a Gaussian illumination beam, which creates a non-uniform illumination that can lead to significant bias towards quantitative measurement of fluorescence intensity for biomarker quantification.

Compared to the above two diffraction limited imaging techniques, STORM imaging can provide a single-molecule level resolution (~20nm), which has the potential to accurately measure the size of exosomes and distinguish crowded exosomes. But this advantage is at the sacrifice of even more throughput and significantly increased complexity and cost. The performance of STORM imaging is also affected by many factors (e.g., limited fluorophores, imaging buffers, and illumination uniformity, etc.), making it less robust for large-scale single exosome analysis. In addition, it is quite difficult for STORM to perform robust multicolor imaging.

In short, despite the superior sensitivity and resolution, existing single exosome analysis is largely limited by: (1) the accuracy and sensitivity based on the fluorescence intensity measurement; (2) the imaging throughput in terms of the number of exosomes analyzed at a time; and (3) the number of biomarker targets imaged on a single exosome.

### SUMMARY OF THE INVENTION

In one embodiment, a total internal reflection fluorescence (TIRF) microscopy system is provided that includes a light source, a light movement apparatus, such as a vibration motor or a 2D scanning device, coupled to an output of the light source, such as an RGB laser, for receiving a first light signal generated by the light source, the light movement apparatus being structured and configured to generate a second light signal from the first light signal, the second light signal being a light signal that moves in at least 2 dimensions, a prism structured to receive the second light signal and direct the second light signal to a sample, a lens assembly structured to receive an emission light signal emitted from the sample in response to the second light signal, and one or more light detectors, such as one or more industry grade cameras, coupled the lens assembly for receiving the emission light signal.

In another embodiment, a total internal reflection fluorescence (TIRF) microscopy method is provided that includes providing a first light signal to a light movement apparatus, generating by the light movement apparatus a second light signal from the first light signal, the second light signal being a light signal that moves in at least 2 dimensions, providing the second light signal to a prism for directing the second light signal to a sample and receiving an emission light signal emitted from the sample in response to the second light signal in one or more light detectors.

### BRIEF DESCRIPTION OF THE DRAWINGS

A full understanding of the invention can be gained from the following description of the preferred embodiments when read in conjunction with the accompanying drawings in which:

FIG. 1 is a schematic diagram of a total internal reflection fluorescence (TIRF) microscopy system according to an exemplary embodiment of the disclosed concept;

FIG. 2 is a schematic diagram showing a light movement apparatus and a pTIRF configuration of the TIRF microscopy system of FIG. 1;

FIG. 3 is a schematic diagram showing a light movement apparatus and a pTIRF configuration according to an alternative embodiment of the disclosed concept that my be used in place of the configuration of FIG. 2; and

FIG. 4 is a block diagram showing a control system of the TIRF microscopy system of FIG. 1 according to an exemplary embodiment of the disclosed concept.

### DETAILED DESCRIPTION OF THE INVENTION

As used herein, the singular form of “a”, “an”, and “the” include plural references unless the context clearly dictates otherwise.

As used herein, the statement that two or more parts or components are “coupled” shall mean that the parts are joined or operate together either directly or indirectly, i.e., through one or more intermediate parts or components, so long as a link occurs.

As used herein, “directly coupled” means that two elements are directly in contact with each other.

As used herein, the term “number” shall mean one or an integer greater than one (i.e., a plurality) As used herein, the term “about” shall mean within 10% or less of a given parameter or value.

As used herein, the term “industry grade camera” shall mean a camera having a noise level of ≥10 e−.

As used herein, the term “scientific grade camera” shall mean a camera having a noise level of ≤2 e−.

As used herein, the term “controller” shall mean a programmable analog and/or digital device (including an associated memory part or portion) that can store, retrieve, execute and process data (e.g., software routines and/or information used by such routines), including, without limitation, a field programmable gate array (FPGA), a complex programmable logic device (CPLD), a programmable system on a chip (PSOC), an application specific integrated circuit (ASIC), a microprocessor, a microcontroller, a programmable logic controller, or any other suitable processing device or apparatus. The memory portion can be any one or more of a variety of types of internal and/or external storage media such as, without limitation, RAM, ROM, EPROM(s), EEPROM(s), FLASH, and the like that provide a storage register, i.e., a non-transitory machine readable medium, for data and program code storage such as in the fashion of an internal storage area of a computer, and can be volatile memory or nonvolatile memory.

As used herein, the terms “component” and “system” are intended to refer to a computer related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

The disclosed concept will now be described, for purposes of explanation, in connection with numerous specific details in order to provide a thorough understanding of the disclosed concept. It will be evident, however, that the disclosed concept can be practiced without these specific details without departing from the spirit and scope of this innovation.

As described in detail herein, the disclosed concept provides a technology platform for hyper-throughput biomarker detection at single molecule sensitivity. The platform of the disclosed concept is built upon an optical configuration of TIRF microscopy, but with several innovation strategies for significantly higher throughput, multiplicity and accuracy, which are well suited for single exosome analysis. The strategies employed in the disclosed concept include ultra-large field of view (~1 mm²) TIRE imaging, high-density exosome detection (10⁵-10⁶ in a single FOV), molecular-counting based multiplex quantitative analysis of biomarkers, and/or super-resolved imaging capability (~30 nm).

The hyper-throughput, multiplex single molecule imaging system of the disclosed concept has ultra-precise single molecule level sensitivity (e.g., molecule number, molecule position). The system is simple (simple to build and simple to use), robust (ultra-high stability), cost-efficient (typically <$20,000), and compact (desktop size). In addition, and importantly, the disclosed concept can provide ultra-high precision (precise molecule number, position) and ultra-high throughput (10⁵-10⁶ per FOV).

Compared to a traditional imaging-based single-exosome analysis platform, the disclosed concept proposes four key innovative strategies to achieve hyper-throughput performance and single-molecule sensitivity in a single-exosome analysis platform: (1) ultra-large flat-field illumination and detection, (2) high-density exosome imaging, (3) single molecule sensitivity, and (4) precise multiplex profiling. Each of these strategies is discussed below.

### 1. Large Flat FOV

The imaging throughput of existing single exosome analysis systems is limited by the small field of view (FOV) of illumination and detection (~0.01 mm²).

Furthermore, the quantification accuracy of single exosome analysis is limited by the non-uniform illumination across the FOV. The disclosed concept uses a light movement apparatus, such as, without limitation, a vibrated square-core multimode fiber or a light scanning device, to transform the non-uniform (uniformity <70%) laser beam output from a low-cost industry laser into a large illumination FOV (~1 mm²) light source with a uniformity better than 99% in the exemplary embodiment. The disclosed concept also uses an active cooling system and specific noise calibration and correction algorithm to transform an industry grade large format camera with a high noise level (>10 e−) into a scientific grade camera (noise <2.5 e−) that can produce high SNR single molecule image. This improvement helps the system achieve a significantly larger detection FOV than state-of-the-art scientific cameras (e.g., 12 times larger than sCMOS, 180 times larger than EMCCD). In the exemplary implementation, the photon response and noise of each pixel of the camera is not identical. In such an implementation, the noise and photon response of each pixel of the camera may be measured and the noise may be calibrated as described in, for example, Diekmann, R., Deschamps, J., Li, Y. et al., “Photon-free (s)CMOS camera characterization for artifact reduction in high-and super-resolution microscopy”, Nat Commun 13, 3362 (2022), the disclosure of which is incorporated herein by reference. In particular, this method includes the following measured camera parameters in the image reconstruction process: (i) pixel-dependent and exposure time-dependent noise, offset and gain maps, and (ii) dark current and thermal noise.

### 2. High-Density Exosome Imaging

Microscopy-based approaches have traditionally been considered to be unfavorable for exosome analysis due to low throughput. Specifically, only a small number of exosomes can be detected within the limited FOV due to the low-density of exosomes (<10² per FOV). The disclosed concept provides a super-resolved resolution (e.g., ~30 nm), and thus can capture a high-density of exosomes without the concern of crowded exosomes. The disclosed concept allows for the detection of a bulk number of exosomes (e.g., 10⁵-10⁶) in single FOV for quantitative analysis, which can significantly improve the sensitivity of single exosome analysis due to limited number of exosomes.

### 3. Single-Molecule Sensitivity

Accurate quantification of biomarkers is crucial for clinical diagnostics and basic research. However, existing methods based on the measurement of fluorescence intensity from individual exosomes can be affected by many factors (e.g., non-uniform illumination, photobleaching, focus bias, etc.), limiting their sensitivity and specificity. The disclosed concept takes advantage of a quantitative single molecule counting technique based on kinetic measurements with dynamically binding imaging probes.

By decoding the kinetic on-off binding event, the single exosome analysis can achieve an ultimate single molecule sensitivity. The molecule counting results are robust against the factors that degraded the existing single exosome analysis systems.

### 4. Precise Multiplex Profiling

Multiplex profiling is an important attribute required for single exosome analysis, as the co-localization of multiple biomarkers on a single exosome is important to decipher its diverse cell of origin and understand its microenvironment, with a great potential to improve diagnostic accuracy. An efficient assessment of combinatorial markers has emerged as a promising way to ultimately develop an objective readout for prognosis, stratification, or therapy monitoring. Conventional multiplex single exosome analysis systems usually require a complex, sequential bleaching-washing-labeling cycle for multiplex imaging, which is harsh to exosomes. The disclosed concept adapts the barcoding strategy by encoding each biomarker with a dye-labeled oligonucleotide with a specific programed sequence to achieve unlimited biomarker profiling capability. The programmable dye-labeled oligonucleotide probes based single molecule localization imaging method is also known as DNA-PAINT, and is described in Schnitzbauer, J., Strauss, M., Schlichthaerle, T. et al., “Super-resolution microscopy with DNA-PAINT”, Nat Protoc 12, 1198-1228 (2017), the disclosure of which is incorporated herein by reference. Its dynamic binding property means it can do single molecule imaging instantly after adding the probe buffer by simply changing the probe contained buffer to achieve sequential multiplex imaging without a bleaching-washing-labeling cycle.

Moreover, the disclosed concept does not need an expensive and complex scanning system as is required in conventional single exosome imaging systems due to its feature of one-FOV for approximately one million exosomes. The disclosed concept also does not need an expensive and complex drift stabilization system as required in conventional single exosome imaging systems due to its feature of intersection-free illumination-detection. It also does not need to carefully dilute the exosome to well separate the exosome due to its single molecule sensing feature.

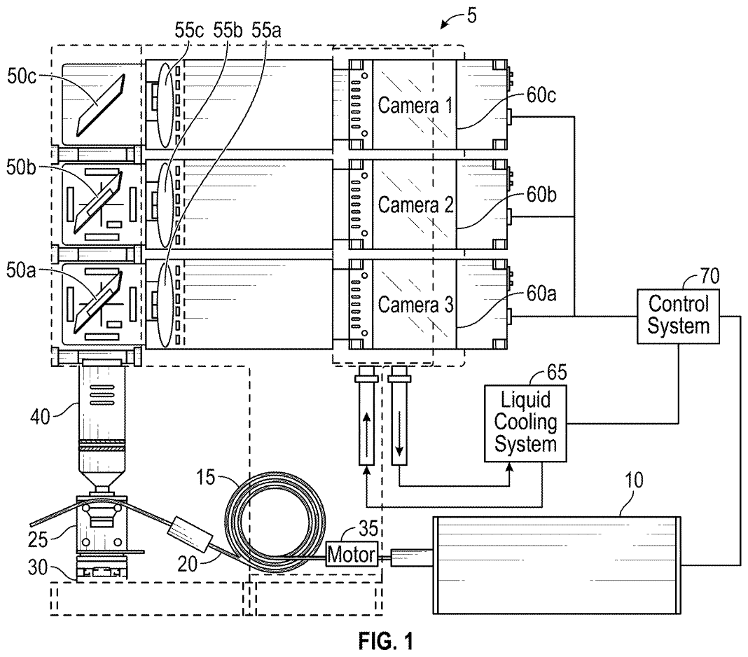

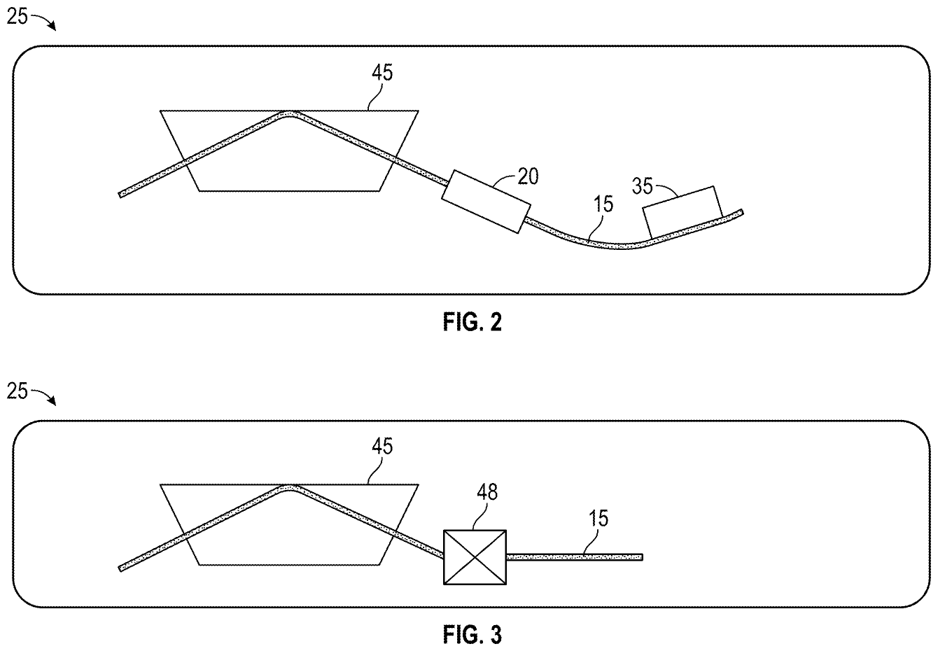

FIG. 1 is a schematic diagram of a TIRF microscopy system 5 according to an exemplary embodiment of the disclosed concept. TIRF microscopy system 5 includes a laser source 10 for generating an illumination light. In the exemplary embodiment, laser source 10 is a 3-color RGB laser (e.g., a 20 W RGB laser with a wavelength of 445 nm, 525 nm and 638 nm in one specific exemplary embodiment). Laser source 10 is coupled to a multimode fiber 15 at a first, receiving end thereof. In the exemplary embodiment, multimode fiber 15 is a multimode fiber with a square core to convert the non-uniform laser beam to a uniform beam with a square shape. The second end of multimode fiber 15 is coupled to a collimator/lens assembly 20 that includes an achromatic collimator and an achromatic lens. In the exemplary embodiment, collimator/lens assembly 20 is structured to generate a near collimated beam with a spot size of~1 mm² (the beam power intensity used for single molecule imaging is ~0.4 KW/cm²). The output of collimator/lens assembly 20 is provided to a prism-based TIRF (pTIRF) configuration 25 supported by a 3-axis stage 30. The near collimated laser beam will go through prism 45 of pTIRF configuration 25 (FIG. 2) and be totally reflected at the coverslip-sample interface and generate evanescent waves (e.g., with a thickness of ~200 nm in the exemplary embodiment).

In addition, a vibration motor 35 is coupled (preferably directly coupled) to multimode fiber 15. In the non-limiting exemplary embodiment, vibration motor 35 is a high frequency motor having an operating frequency ≥10 Hz. Vibration motor 35 functions to eliminate the interference speckle and achieve a high uniform illumination field (e.g., uniformity >95%). FIG. 2 is a schematic diagram showing multimode fiber 15, collimator/lens assembly 20, pTIRF configuration 25 (including prism 45 thereof), and vibration motor 35 of this embodiment, including the path of the laser light through prism 45. FIG. 3 is a schematic diagram of an alternative embodiment of the disclosed concept wherein a 2D scanning device 48 is used to eliminate the interference speckle and achieve a high uniform illumination field (e.g., uniformity >95%) in place of vibration motor 35 and collimator/lens assembly 20. 2D scanning device 48 may be a galvanometer based system having two or more galvo scan mirrors to scan the laser in two dimensions. Such a system may be a Galvo Scan Head (also called laser marking head or laser scanner) that includes two scan mirrors, two galvanometers (or called galvo-scanner motor) and drive cards, an XY mount, a scanning lens, an interface card (or called D/A card), a set of marking software and a DC power supply.

The pTIRF configurations just described are advantageous, as they enable ultra-stable single molecule imaging. More specifically, the illumination and detection paths of an objective TIRF (oTIRF) configuration share many optical elements, and thus it is not easy to avoid the thermal effect when a high power laser is used. This can introduce significant focus drift during imaging (50 nm/min). In contrast, the pTIRF configuration employed in the exemplary embodiment of the disclosed concept separates the illumination path from detection path, and thus it is easier to achieve thermal equilibrium and realize a high focus stability (e.g., 5 nm/min). In addition, the simple geometry of the pTIRF configuration of the disclosed concept ensures that it generates minimal stray light (e.g., <1%) from interface scattering as compared to oTIRF (~15%), which further improves the signal-to-background ratio and reduces the non-specific detection.

Moreover, in a further aspect of the disclosed concept, the residual drift can be further compensated using a novel post-processing algorithm developed by the present inventors, which is referred to as Adaptive localization Intersection based Drift (AID) correction (AID) and which is described in PCT Application No.

PCT/US2023/078142, titled “Drift-Free High-Throughput Localization Microscopy”, the disclosure of which is incorporated herein by reference. AID correction is the first post-processing algorithm to achieve sub-nanometer and sub-second speed drift compensation, and can further improve system stability for single-molecule detection according to the disclosed concept.

Referring again FIG. 1, TIRF microscopy system 5 further includes an objective lens 40, filter/mirror assemblies 50a, 50b, 50c, lenses 55a, 55b, and 55c, and cameras 60a, 60b, and 60c. Filter/mirror assembly 50a and lens 55a are configured to direct blue light to camera 60a, filter/mirror assembly 50b and lens 55b are configured to direct green light to camera 60a, and filter/mirror assembly 50c and lens 55c are configured to direct red light to camera 60a.

Generally, in the prior art, only scientific grade cameras (e.g., EMCCD-based cameras and sCMOS-based cameras) are considered for single molecule imaging or other weak-signal scenarios due to their guaranteed low noise. However, the rather limited sensor size (e.g., 0.26 MP for a typical EMCCD-based camera and 4MP for a typical sCMOS-based camera) and high unit price (e.g., $15K-$40K) of scientific grade cameras make it difficult to use them for hyper-throughput single molecule imaging by using a camera array. To address this problem, the disclosed concept, in one aspect, uses a large format industry grade camera (e.g., 47 MP costing approximately $2.5K) to significantly enlarge the single molecule detection FOV.

Specifically, in the exemplary embodiment, an industry grade camera is able to provide a FOV approximately 12 times larger than an sCMOS camera and approximately 180 times larger than an EMCCD cameras. To reduce the inherent high noise level of industry grade cameras and make them suitable for single molecule detection, the disclosed concept employs two features. First, an active liquid cooling system is employed to reduce the camera working temperature from ~60° C. to room temperature (20° C.). This step can help to dramatically reduce dark noise from approximately 12e− to approximately 0.5e−, which is close to the scientific grade cameras and sufficient for single molecule detection with high SNR. Second, the disclosed concept calibrates the independent noise of each pixel to eliminate the influence of non-uniform noise and uses the noise-specific denoising algorithm described elsewhere herein to obtain a high SNR image.

Thus, according to this aspect of the disclosed concept, each camera 60 is an industry grade camera in the exemplary embodiment, and TIRF microscopy system 5 includes an active liquid cooling system 65 operatively coupled to cameras 60a, 60b, and 60c. As noted above, liquid cooling system 65 functions to reduce the working temperature of cameras 60a, 60b, and 60c from ~60° C. to room temperature (20° C.).

This step can help to dramatically reduce dark noise from approximately 12e− to approximately 0.5e−, which is close to a scientific grade camera and sufficient for single molecule detection with high SNR. As a result, and along with the described noise calibration and correction, cameras 60a, 60b, and 60c can achieve a detection FOV of ~1 mm² with an equivalent pixel size of 150 nm. In addition, the use of three cameras 60a, 60b, and 60c, one for each color-channel for simultaneous 3-color single molecule imaging, further improves the throughput of the system.

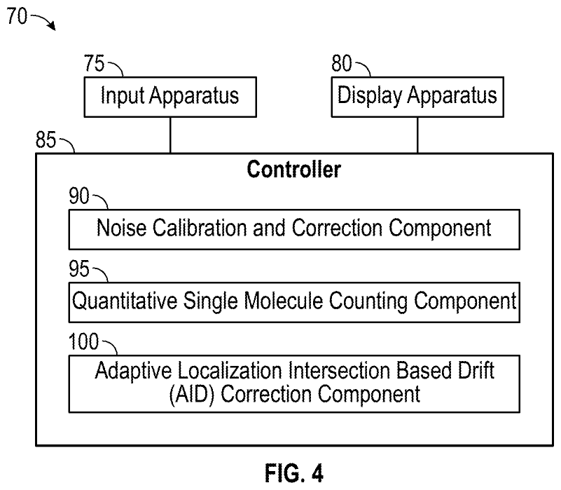

Finally, TIRF microscopy system 5 includes a control system 70 which is structured and configured to control the operation of TIRF microscopy system 5 as described herein, including the processing of image data generated by cameras 60a, 60b, and 60c. FIG. 4 is a schematic diagram of an exemplary control system 70 according to an exemplary embodiment of the disclosed concept. As seen in FIG. 4, control system 70 is a computing device structured and configured to receive digital image data representing a number of images generated by cameras 60a, 60b, and 60c, and process that data as described herein. Control system 70 may be, for example and without limitation, a PC, a laptop computer, or any other suitable device structured to perform the functionality described herein. Control system 70 includes an input apparatus 75 (such as a keyboard), a display apparatus 80 (such as a liquid crystal display (LCD)), and a controller 85. A user is able to provide input into controller 85 using input apparatus 75, and controller 85 provides output signals to display apparatus 80 to enable display apparatus 80 to display information to the user (such as images generated from a sample) as described in detail herein. The memory portion of controller 85 has stored therein a number of routines (comprising computer executable instructions) that are executable by the processor portion of controller 85, including routines for implementing the disclosed concept as described herein. In particular, controller 85 includes a noise calibration and correction component 90 for calibrating and correcting the noise and photon response of each pixel of each camera 60a, 60b, 60c as described herein using the following measured camera parameters in the image reconstruction process: (i) pixel-dependent and exposure time-dependent noise, offset and gain maps, and (ii) dark current and thermal noise. Controller 85 also includes a quantitative single molecule counting component 95 for single molecule counting that is based on kinetic measurements with dynamically binding imaging probes as described herein. Controller 85 also further includes an AID correction component 100 configured for measuring and/or compensating for sample drift during data acquisition as described herein.

As noted above, one aspect of the disclosed concept provides a quantitative single molecule counting technique that may be implemented in quantitative single molecule counting component 95 that is based on kinetic measurements with dynamically binding imaging probes. Dynamically binding imaging probes exhibit kinetic on-off binding events, and by decoding the kinetic on-off binding events, the single exosome analysis can achieve an ultimate single molecule sensitivity. In addition, the molecule counting results according to this aspect of the disclosed concept are robust against the factors that degrade existing single exosome analysis systems. In the exemplary embodiment, this aspect of the disclosure concept involves three steps: (1) single molecule localization, (2) single molecule counting, and (3) single exome clustering, each of which is described below.

With respect to the first step (single molecule localization), single-molecule imaging systems require a dedicated single-molecule localization algorithm to retrieve the precise position and brightness of each single molecule. For hyper-throughput single-molecule detection, billions of single molecules need to be localized. For this purpose, the disclosed concept uses an ultrafast harmonic-analysis based 3D localization algorithm previously developed by the present inventors for precise estimation of the 3D position and brightness (at about 1 MHz speed) of each molecule. That algorithm is described in U.S. Patent Application Publication No. 2020/116,380, titled “Systems and Methods for Robust Background Correction and/or Emitter Localization for Super-Resolution Localization Microscopy,” the disclosure of which is incorporated herein by reference. The precision of this algorithm is close to the state-of-the-art PSF fitting-based algorithm (spline fitting), with ~200 times faster speed, which enables real-time high-throughput data processing. Furthermore, traditional single-molecule localization-based imaging requires a large number of imaging frames (~20000 frames) to accumulate a sufficient number of molecules for accurate quantification. To improve the imaging throughput of the disclosed concept, it increases the single-molecule density at each frame, thus reducing the required frame number to 6000 frames and improving the imaging speed for each FOV.

With respect to the second step (single molecule counting), conventional biomarker quantification in single exosome analysis is based on the measurement of their corresponding fluorescence intensity. This approach, however, can be easily affected by many factors (e.g., non-uniform illumination, photobleaching, and focus drift), which limit its quantification accuracy. To address this problem, the disclosed concept uses programmable dye-labeled oligonucleotide probes to achieve precise single-molecule counting. This approach explicitly decouples the blinking from the photo-physics of fluorophores. This approach is also robust to photobleaching, as dye-labeled oligonucleotides probes are continuously replenished from the solution.

Therefore, this approach can simultaneously achieve high accuracy, precision, a wide dynamic range, robustness, and multiplexing capability for quantifying a number of labeled targets. The binding and unbinding kinetics of dye-labeled oligonucleotides probes is determined by a specific combination of oligonucleotides for a fixed concentration. The temporal kinetics of each oligo probes can be used for multicolor imaging. This aspect of the disclosed concept adapts the DNA origami-based imaging quality benchmark platform and calculates the ON/OFF ratio of different numbers of binding sites. Then, a calibration look-up-table is used to determine the number of targets in each exosome.

With respect to the third step (single exome clustering), the disclosed concept maps the reconstructed single molecule counting data set from step two onto a 2D plane using tSNE (t-distributed stochastic neighbor embedding) to cluster the exosomes. This approach uses the marker expression levels (counted molecules) to define populations and can identify the exosome populations in a data-driven manner. In addition, tSNE can visualize high-dimensional data with a large amount of populations by giving each population a location in a two-dimensional map.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A total internal reflection fluorescence (TIRF) microscopy system, comprising:
a light source;
a light movement apparatus coupled to an output of the light source for receiving a first light signal generated by the light source, the light movement apparatus being structured and configured to generate a second light signal from the first light signal, the second light signal being a light signal that moves in at least 2 dimensions;
a prism structured to receive the second light signal and direct the second light signal to a sample;
a lens assembly structured to receive an emission light signal emitted from the sample in response to the second light signal; and
one or more light detectors coupled the lens assembly for receiving the emission light signal.

2. The TIRF microscopy system according to claim 1, wherein the light movement apparatus comprises a fiber portion coupled to an output of the light source for receiving the first light signal, and a vibration motor coupled to the fiber portion for vibrating the fiber portion while the fiber portion is receiving the first light signal.

3. The TIRF microscopy system according to claim 2, wherein the fiber portion includes a square-core multimode fiber, 4. The TIRF microscopy system according to claim 2, wherein the vibration motor is structured to operate at a vibration frequency of greater than or equal to about 10 Hz.

5. The TIRF microscopy system according to claim 2, wherein the fiber portion includes an achromatic collimator and an achromatic lens such that the second light signal will be a near collimated beam.

6. The TIRF microscopy system according to claim 1, wherein the light movement apparatus comprises a 2-dimensional light scanning device.

7. The TIRF microscopy system according to claim 1, wherein the 2-dimensional light scanning device includes a first scan mirror and a second scan mirror for scanning the second light signal in two dimensions.

8. The TIRF microscopy system according to claim 1, wherein the one or more light detectors comprise one or more cameras.

9. The TIRF microscopy system according to claim 8, wherein the light source is an RGB laser source, and wherein the one or more cameras include first, second and third cameras, wherein the lens assembly structured is structured and configured to direct a red portion of the emission light signal to the first camera, to direct a green portion of the emission light signal to the second camera, and to direct a blue portion of the emission light signal to the third camera.

10. The TIRF microscopy system according to claim 8, wherein each of the one or more cameras is an industry grade camera, and wherein the TIRF microscopy system further includes a cooling system coupled to the one or more cameras and structured to reduce a working temperature of the one or more cameras to about room temperature.

11. The TIRF microscopy system according to claim 10, wherein the cooling system is an active liquid cooling system.

12. The TIRF microscopy system according to claim 8, further comprising a control system structured and configured to receive a signal from each of the one or more cameras, wherein the control system is structured and configured to implement a noise calibration and correction component structured and configured to correct a noise and photon response of each pixel of each of the one or more cameras.

13. The TIRF microscopy system according to claim 12, wherein the noise calibration and correction component is structured and configured to use the following measured parameters for each of the one or more cameras in an image reconstruction process: (i) pixel-dependent and exposure time-dependent noise, offset and gain maps, and (ii) dark current and thermal noise.

14. The TIRF microscopy system according to claim 1, further comprising a control system structured and configured to receive a signal from each of the one or more light detectors, wherein the control system is structured and configured to implement a quantitative single molecule counting component structured and configured for single molecule counting based on kinetic measurements made with dynamically binding imaging probes.

15. The TIRF microscopy system according to claim 14, wherein the dynamically binding imaging probes comprise programmable dye-labeled oligonucleotide probes.

16. The TIRF microscopy system according to claim 14, wherein quantitative single molecule counting component calculates an ON/OFF ratio of a number different binding sites of dynamically binding imaging probes.

17. The TIRF microscopy system according to claim 1, wherein the TIRF microscopy system achieves a detection field of view (FOV) of about 1 mm².

18. The TIRF microscopy system according to claim 1, wherein the TIRF microscopy system has a resolution of about 30 nm.

19. The TIRF microscopy system according to claim 1, wherein the TIRF microscopy system is capable of detecting 10⁵-10⁶ exosomes in a single field of view.

20. The TIRF microscopy system according to claim 1, further comprising a control system structured and configured to receive a signal from each of the one or more light detectors, wherein the control system is structured and configured to implement Adaptive localization Intersection based Drift (AID) correction component for measuring and compensating for sample drift.

21. A total internal reflection fluorescence (TIRF) microscopy method, comprising:
providing a first light signal to a light movement apparatus;
generating by the light movement apparatus a second light signal from the first light signal, the second light signal being a light signal that moves in at least 2 dimensions;
providing the second light signal to a prism for directing the second light signal to a sample; and
receiving an emission light signal emitted from the sample in response to the second light signal in one or more light detectors.

22. The TIRF microscopy method according to claim 21, wherein the light movement apparatus comprises a fiber portion for receiving the first light signal, and a vibration motor coupled to the fiber portion for vibrating the fiber portion while the fiber portion is receiving the first light signal.

23. The TIRF microscopy method according to claim 22, wherein the fiber portion includes a square-core multimode fiber,

24. The TIRF microscopy method according to claim 22, wherein the fiber portion includes an achromatic collimator and an achromatic lens such that the second light signal will be a near collimated beam.

25. The TIRF microscopy method according to claim 21, wherein the light movement apparatus comprises a 2-dimensional light scanning device,

26. The TIRF microscopy method according to claim 21, wherein the one or more light detectors comprise one or more cameras.

27. The TIRF microscopy method according to claim 26, wherein the light source is an RGB laser source, and wherein the one or more cameras include first, second and third cameras, the method comprising directing a red portion of the emission light signal to the first camera, a green portion of the emission light signal to the second camera, and a blue portion of the emission light signal to the third camera.

28. The TIRF microscopy method according to claim 26, wherein each of the one or more cameras is an industry grade camera, and wherein the method includes actively cooling the one or more cameras to reduce a working temperature of the one or more cameras to about room temperature.

29. The TIRF microscopy method according to claim 26, further comprising receiving a signal from each of the one or more cameras and correct a noise and photon response of each pixel of each of the one or more cameras, 30. The TIRF microscopy method according to claim 29, further comprising using the following measured parameters for each of the one or more cameras in an image reconstruction process: (i) pixel-dependent and exposure time-dependent noise, offset and gain maps, and (ii) dark current and thermal noise.

31. The TIRF microscopy method according to claim 21, further comprising performing single molecule counting based on the emission light using kinetic measurements made with dynamically binding imaging probes.

32. The TIRF microscopy method according to claim 31, wherein the dynamically binding imaging probes comprise programmable dye-labeled oligonucleotide probes.

33. The TIRF microscopy method according to claim 31, wherein the single molecule counting calculates an ON/OFF ratio of a number different binding sites of dynamically binding imaging probes.
